(19) United States
(12) Patent Application Publication
(10) Pub. No.: US 2016/0182769 A1
(43) Pub. Date: Jun. 23, 2016

(54) APPARATUS AND METHOD FOR GENERATING MOTION EFFECTS BY ANALYZING MOTIONS OF OBJECTS

(71) Applicant: POSTECH ACADEMY - INDUSTRY FOUNDATION, Pohang-si (KR)

(72) Inventors: Seung Moon CHOI, Pohang-si (KR); Jae Bong LEE, Pohang-si (KR)

(21) Appl. No.: 14/969,757

(22) Filed: Dec. 15, 2015

(30) Foreign Application Priority Data
Dec. 19, 2014 (KR) 10-2014-0184271

(51) Int. Cl. H04N 5/14; G06K 9/00; G06K 9/46; G06T 7/20; H04N 5/232

(52) U.S. Cl. CPC H04N 5/144; G06T 7/2033; G06T 7/2053; H04N 5/23254; G06K 9/46; G06K 9/00711; G06T 2207/30241

(57) ABSTRACT

Disclosed are apparatuses and methods for generating motion effects in real time by analyzing motions of interest objects in a video. The motion effect generation apparatus may comprise an extraction part extracting motions between sequential frames by calculating relations of respective pixels of the sequential frames in a video signal; a clustering part generating clusters of similar motions by grouping the motions; a computation part calculating a representative motion of each of the clusters; and a selection part selecting a cluster suitable for generating a motion effect from the clusters by comparing the representative motions of the clusters, and output the representative motion of the cluster selected by the selection part as the motion effect or motion information for the motion effect.

### CROSS-REFERENCE TO RELATED APPLICATIONS

This application claims priority to Korean Patent Application No. 10-2014-0184271 filed on Dec. 19, 2014 in the Korean Intellectual Property Office (KIPO), the entire contents of which are hereby incorporated by reference.

### BACKGROUND

1. Technical Field

The exemplary embodiments of the present disclosure relate to a technology for generating motion effects, and more particularly to apparatuses for generating motion information or motion effects in real time by analyzing motions of objects in a video, and methods for the same.

2. Related Art

Usually, motion effects may mean techniques for reproducing realistic experiences, which can provide users with motions or shocks according to music or movies whereby the users can enjoy the content head and ears.

As examples of the content to which the motion effects are applied, there may be three-dimensional (3D) or four-dimensional (4D) movies which can give feeling of immersion by providing various physical atmospheres such as motion of chairs, vibrations, winds, and scents in addition to simple images and sounds. Also, among the various motion effects, motion effects which produce atmosphere of video in reality by giving motions to chairs according to the video being played act the most important role in the 4D movies.

In order to generate such the motion effects, a professional producer should generate the motion effects one by one. Therefore, it takes much time and costs to produce the content to which the motion effects are applied.

Also, in order to generate motion effects which are applied to the motion apparatus, it is necessary to prepare motion information as source information for the motion effects. Since the preparation of the motion information requires professional facilities and tasks of professional persons, too much cost and time are demanded for the preparation, and it is difficult to generate the motion information in real time.

### SUMMARY

Accordingly, exemplary embodiments of the present disclosure provide apparatuses for analyzing motions of objects in a provided video and automatically generating motion information for 4D effects suitable to the motions of objects, and methods for the same.

Also, exemplary embodiments of the present disclosure provide apparatuses for obtaining motion information from a provided video and automatically generating motion effects which can be realized by a motion apparatus, and methods for the same.

In order to achieve the objectives of the present disclosure, a motion effect generation apparatus may be provided. The motion effect generation apparatus may comprise an extraction part extracting motions between sequential frames by calculating relations of respective pixels of the sequential frames in a first video signal; a clustering part generating clusters of similar motions by grouping the motions; a computation part calculating representative motions of respective clusters; and a selection part selecting a cluster suitable for generating a motion effect among the clusters by comparing the representative motions of the respective clusters. Also, the apparatus may outputs\ motion information of the motion effect based on the representative motion of the cluster selected by the selection part.

Here, the apparatus may further comprise a generation part generating the motion effect based on the representative motion of the cluster selected by the selection part. Also, the generation part may use a washout filter or a trajectory planning method.

Here, the apparatus may further comprise a synchronization part outputs a second video signal delayed for a predetermined time as compared to the first video signal inputted to the extraction part, and the second video signal is synchronized with the motion effect outputted by the generation part.

Here, the extraction part may use an optical flow method or a feature point matching method.

Here, the clustering part may use a K-means clustering method, a single linkage clustering method, or a spectral clustering method.

Here, the computation part may select arithmetic means or median values of all motions of the respective clusters as the representative motions for respective clusters.

Here, the selection part may select a cluster whose representative motion has the largest absolute value or a cluster having the largest visual saliency as the cluster suitable for generating the motion effect.

In order to achieve the objectives of the present disclosure, a motion effect generation method may be provided. The method may comprise extracting motions between sequential frames by calculating relations of respective pixels of the sequential frames in a first video signal; generating clusters of similar motions by grouping the motions; calculating representative motions of respective clusters; and selecting a cluster suitable for generating a motion effect among the clusters by comparing the representative motions of the clusters.

Here, the method may further comprise generating the motion effect based on the representative motion of the selected cluster.

Here, the generating clusters may use a washout filter or a trajectory planning method.

Here, the method may further comprise outputting a second video signal delayed for a predetermined time as compared to the first video signal wherein the second video signal is synchronized with the motion effect.

Here, the extracting may use an optical flow method or a feature point matching method.

Here, the generating clusters may use a K-means clustering method, a single linkage clustering method, or a spectral clustering method.

Here, in the calculating the representative motions, arithmetic means or median values of all motions of the respective clusters may be calculated as the representative motions for the respective clusters.

Here, in the selecting the cluster, a cluster whose representative motion has the largest absolute value or a cluster having the largest visual saliency as the cluster suitable for generating the motion effect may be selected.

In order to achieve the objectives of the present disclosure, a motion effect generation apparatus may be provided. The motion effect generation apparatus may comprise a video signal synchronization module outputting a first video signal based on an input video signal and outputting a second video signal delayed from the first video signal; a motion information generation module outputting motion information based on a representative motion of a cluster selected from the first video signal; and a motion effect generation module generating a motion effect based on the motion information and outputting the motion effect synchronized with the second video signal. Also, the motion information generation module extracts motions between two frames by calculating relations of respective pixels of the two frames in the first video signal, generates clusters of similar motions by aggregating the motions, calculates representative motions of respective clusters, selects a cluster suitable for generating a motion effect from the clusters by comparing the representative motions of the clusters, and outputs the representative motion of the selected cluster as the motion effect.

Here, at least one of the video signal synchronization module, the motion information generation module, and the motion effect generation module may be executed by a processor.

Here, the apparatus may further comprise at least one of a memory system, an input/output device, and a communication device for providing the input video signal.

According to the exemplary embodiments of the present disclosure, the apparatuses and methods for generating motion effects, which analyze motions of objects in a video and automatically generate motion information for 4D effects suitable for the motions, are provided. Therefore, time and efforts required for preparing the motion effect of the motion apparatus or the motion information for the same can be remarkably reduced, and real-time motion effects can be output from the motion apparatus through the real-time provision of the motion information.

Also, according to the exemplary embodiments of the present disclosure, a computer-readable recording medium on which a program code for executing the motion effect generation method is recorded can be provided. Since the automatically-generated motion effects can give feeling of realism which is similar to that produced by a professional operator, the time and cost required for producing motion effects can be remarkably reduced.

Also, according to the exemplary embodiments of the present disclosure, the time and cost needed for producing 4D movies to which motion effects are applied can be reduced. In addition, since it can automatically generate motion effects for given motion information or event information in real time, it can be easily applied to 4D movie theaters, 4D rides, home theater equipment, and home game machines.

### BRIEF DESCRIPTION OF DRAWINGS

Exemplary embodiments of the present invention will become more apparent by describing in detail exemplary embodiments of the present invention with reference to the accompanying drawings, in which:

FIG. 1 is a flow chart illustrating a motion effect generation method according to an exemplary embodiment of the present disclosure;

FIG. 2 is an exemplary view to explain a feature point detection procedure for the motion effect generation method of FIG. 1;

FIG. 3 is an exemplary view to explain a shift key point image which can be applied to the motion effect generation method of FIG. 1;

FIG. 4A through FIG. 4G are exemplary views explaining a video to which the motion effect generation method of FIG. 1 is applied;

FIG. 5 is a block diagram of a motion effect generation apparatus based on the motion effect generation method of FIG. 1; and

FIG. 6 is a block diagram illustrating a variation of the motion effect generation apparatus in FIG. 5.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or clusters thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

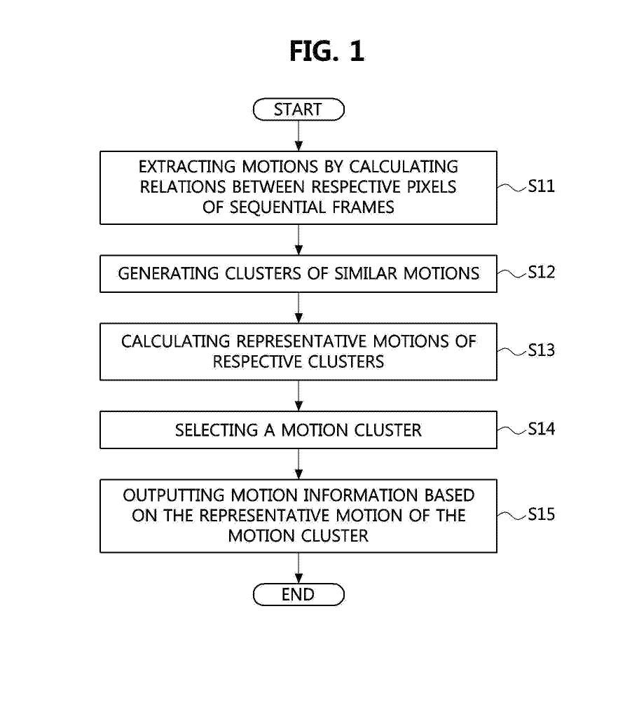

FIG. 1 is a flow chart illustrating a motion effect generation method according to an exemplary embodiment of the present disclosure.

The motion effect generation method according to an exemplary embodiment may be executed by the motion effect generation apparatus. The motion effect generation apparatus may comprise a memory system storing a program code and a processor which is connected to the memory system and executes the program code. Also, the processor of the apparatus may comprise means for performing each step of the method or components for performing respective steps of the method. Here, the means and components may include an extraction part, a clustering part, a computation part, and a selection part, which will be explained.

Referring to FIG. 1, when sequential frames (e.g., two adjacent frames) exist in an input video signal, a motion effect generation apparatus may extract motions by calculating relations between respective pixels of the two frames (S11).

In order to perform the step S11, an extraction unit of the apparatus may use an optical flow or a feature point matching method based on scale invariant feature transform (SIFT). However, various exemplary embodiments are not restricted thereto. That is, any methods which can calculate relations between corresponding points of two frames may be used for the exemplary embodiment, without restricting to the optical flow method.

If the optical flow is calculated, the apparatus may extract information on which point of a next frame a specific pixel of a current frame moves to, and the information may correspond to a motion.

Here, the optical flow may mean a task for tracking motions of an object in a frame or a result of the task. A dense optical flow, a type of optical flows, may indicate a task for calculating velocities or velocity fields of all pixels in the video based on the fact that a velocity of a pixel is related to a displacement of the pixel between a current frame and a next frame. For example, a Horn-Schunck method is one of methods for calculating such the velocity field. The Horn-Schunck method configures pixel windows in a current frame, and searches regions in a next frame which coincide with the corresponding window of the current frame. However, the Horn-Schunck method has a very high computational complexity. On the contrary, a sparse optical flow designates a point (e.g., a corner) having noticeable characteristics as a point to be tracked in advance. Thus, the sparse optical flow is preferred as a method having lower computational complexity.

Also, a Lucas-Kanade (LK) method uses the sparse optical flow. In the LK method, pixel windows are configured in a frame, and points which respectively coincide with the windows are searched in a next frame. However, since the LK method uses small local windows, there is a problem that motions having sizes greater than the size of the windows cannot be calculated. In order to resolve the above problem, a pyramid may be used. In the pyramid LK algorithm, an image pyramid is configured from an original video, and motions are tracked from a lower layer to an upper layer of the pyramid so that large motions can be found.

The above-described step S11 may correspond to a scale-space extrema detection step (i.e., a first step) of the feature point matching method based on SIFT for detecting an extrema (i.e., a region having locally noticeable characteristics) in the scale-space.

Then, the motion effect generation apparatus may generate clusters of similar motions (S12). That is, a clustering part of the apparatus may generate the clusters of similar motions by grouping the motions.

The step S12 may correspond to a key point localization step (i.e., a second step) of the feature point matching method based on SIFT for selecting a point or a part having the highest degree of precision by sorting out noises or error points from many candidate points of the scale-space.

Then, the motion effect generation apparatus may calculate a representative motion for each of the clusters (S13). A computation part of the apparatus may calculate an arithmetic mean or a median value as a representative motion for each of the clusters which are formed by clustering similar motions.

The step S13 may correspond to an orientation assignment step (i.e., a third step) of the feature point matching method based on SIFT for deriving a direction designated by pixels of the representative motion and rotating a frame to set the derived direction to the direction of 0 degree.

Then, the motion effect generation apparatus may select a cluster which is the most suitable for a desired motion effect or the specific motion apparatus as a ‘motion cluster’ (S14). A selection part of the apparatus may compare representative motions of the clusters. Based on the comparison result, the selection part may select a cluster whose representative motion has the largest absolute value as the motion cluster, or select a cluster having the largest saliency as the motion cluster.

The step S14 may correspond to a key point descriptor step (i.e., a fourth step) of the feature point matching method based on SIFT for storing a SIFT descriptor for the rotated partial image in a data base after the orientation assignment step.

Then, the motion effect generation apparatus may generate a motion effect or motion information for the motion effect based on the representative motion of the motion cluster (S15). In this step, a generation part of the apparatus may perform matching of a corresponding frame and feature points of motion information by using washout filter or trajectory planning method to generate the motion effect.

The step 15 may correspond to a key point matching step (i.e., a fifth step) of the feature point matching method based on SIFT for matching feature points stored in the data base and feature points of an image or a target in the image by comparing distances between them. Also, the step S15 may further comprise a step for performing additional matching based on Hough transform and matching verification using a least mean square method according to various exemplary embodiments.

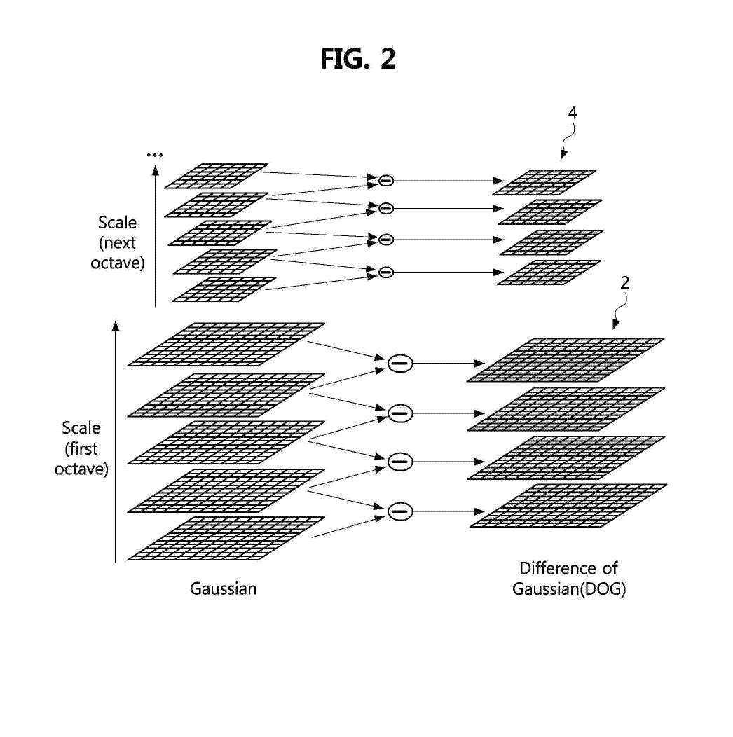

FIG. 2 is an exemplary view to explain a feature point detection procedure for the motion effect generation method of FIG. 1.

In a feature point detection procedure according to an exemplary embodiment, scale spaces for each frame may be configured in predefined shape by applying a Gaussian function to calculate relations of respective pixels of two frames 2 and 4 in the video. The two frames may be temporally adjacent. However, at least one frame may exist between the two frames.

That is, as illustrated in FIG. 2, the extraction part of the motion effect generation apparatus may extract motions from the two frames by using different sigmas (σ) representing width of Gaussian distribution for the two frames and calculating the relations based on difference of Gaussian (DOG) between the two frames.

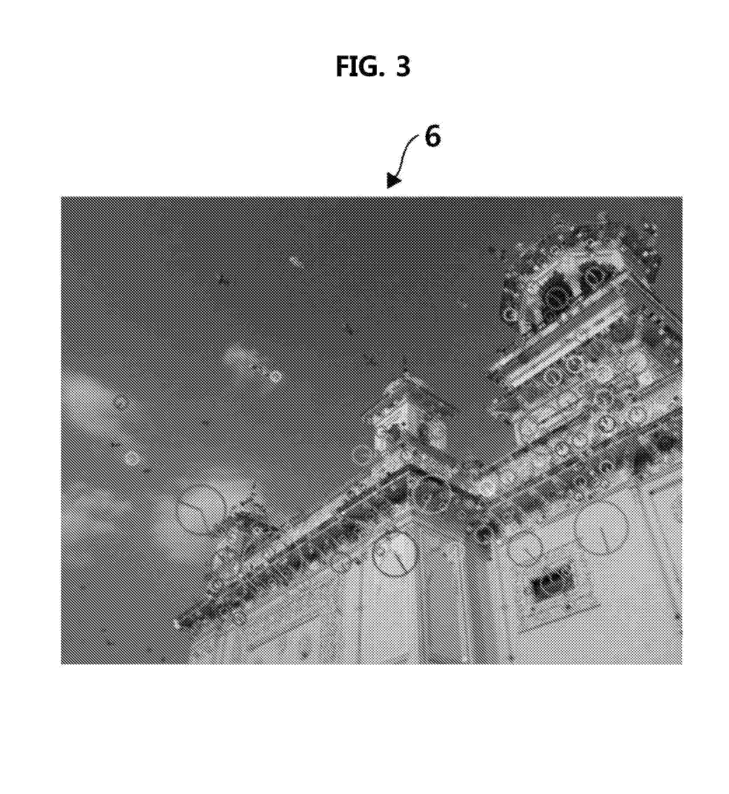

FIG. 3 is an exemplary view to explain a shift key point image which can be applied to the motion effect generation method of FIG. 1.

Referring to FIG. 3, a shift key point image 6 may include a plurality of small circles having different sizes in positions of key points.

More specifically, the motion effect generation apparatus may calculate relations of respective pixels and group them into clusters having similar flows. In this instance, the clustering part may calculate the flows by using a K-means clustering method or a spectral clustering method (or, a normalized cut method). Through this, the motion effect generation apparatus may group adjacent pixels having similar motions into a same cluster. For example, if it is presumed that a person stretches his right arm to the right direction in the video, pixels locating near the stretched right arm may be grouped into a cluster, and other pixels locating in other parts of his body may be grouped into other clusters.

The pattern recognition may be classified into classification and clustering. When classes of respective data are already-known, the classification of data may become a problem. However, when the classes of respective data are not known, classifying data according to similarity may become a problem of clustering. Also, in case that it requires much cost to label respective data with specific classes due to the large number of data, the clustering may be used.

The K-means clustering method, one of the clustering methods, uses an algorithm of grouping data set into K clusters. Each of the K clusters may have a representative vector which is an average of data belonging to each cluster. Thus, a first step of the K-means clustering may start from determination of representative vectors of respective clusters. However, since advance information on which clusters respective data belong to is not given, the K-means clustering method may start with arbitrarily-determined K representative vectors. Then, through appropriate repetitions, proper clusters and representative vectors may be determined.

As described above, the motion effect generation apparatus may calculate representative vectors of respective clusters. The calculation may be performed using various methods. The easiest method is to calculate an arithmetic mean of all flows of each cluster or to calculate a median value of all flows of each cluster. That is, the motion effect generation apparatus may calculate arithmetic means of all flows of respective clusters or obtain median values of all flows of respective clusters to determine representative motions of respective clusters.

Then, the motion effect generation apparatus may select a cluster (i.e., a motion cluster) suitable to generate a motion effect. The selection may also be performed by using various methods. For example, the selection part may select a cluster having a representative motion whose absolute value is the largest. In this case, the motion effect is generated in accordance with the biggest motion in the video. Alternatively, the selection part may select a cluster having the largest visual saliency by calculating visual saliencies of representative motions in respective clusters. In this case, the motion effect is generated in accordance with the most remarkable motion of the object in the video.

Finally, the motion effect generation apparatus may generate motion information for the motion effect based on the representative motion of the selected cluster (motion cluster). The generation of the motion effect may be performed by converting calculated motion information of the object (e.g., interest object) into the motion effect of the motion apparatus (e.g., 4D motion apparatus such as a motion chair), through a classical washout filter or a trajectory planning method used in a robotics domain. Here, the classical washout filter is the most typical control method used for controlling 4D motion apparatuses, and has been developed for controlling a flight simulator of National Aeronautics and Space Administration (NASA), etc. Also, the motion effect or the motion information may be calculated based on a change of time-dependent velocity or a change of time-dependent acceleration.

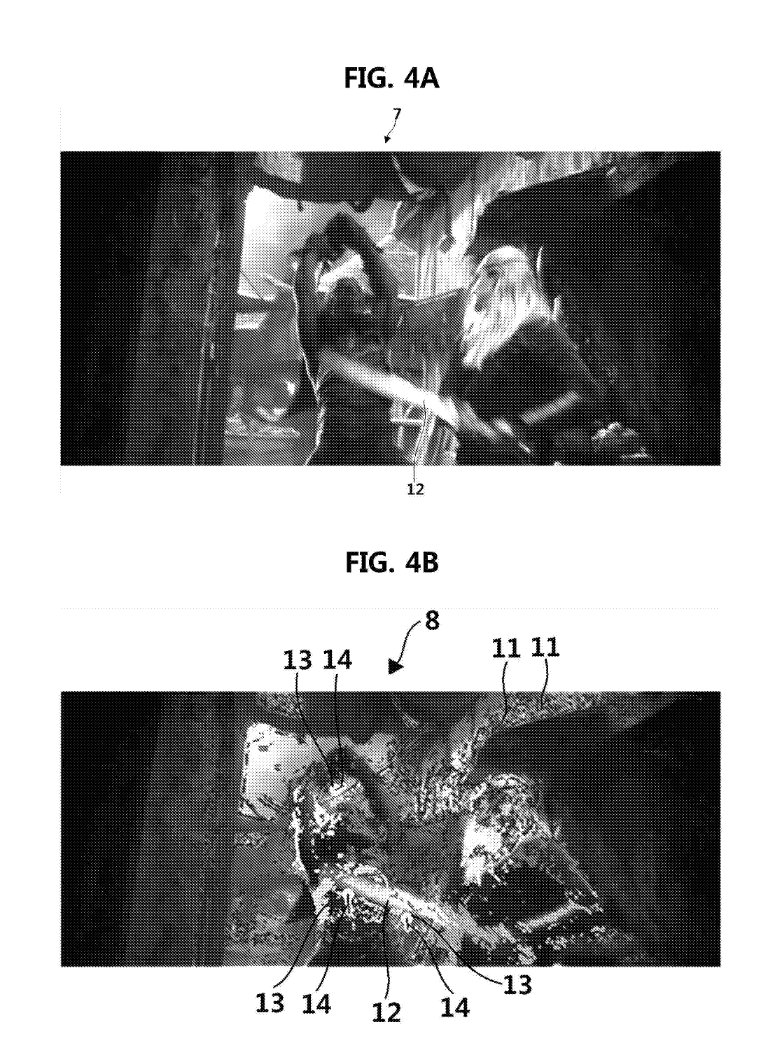

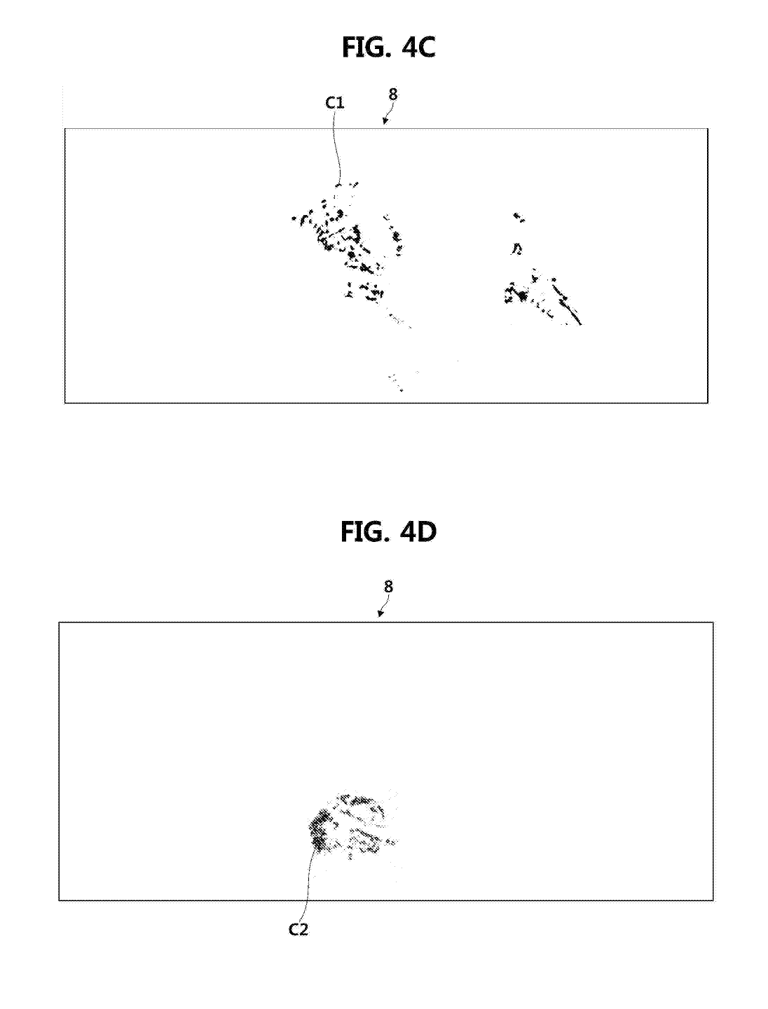

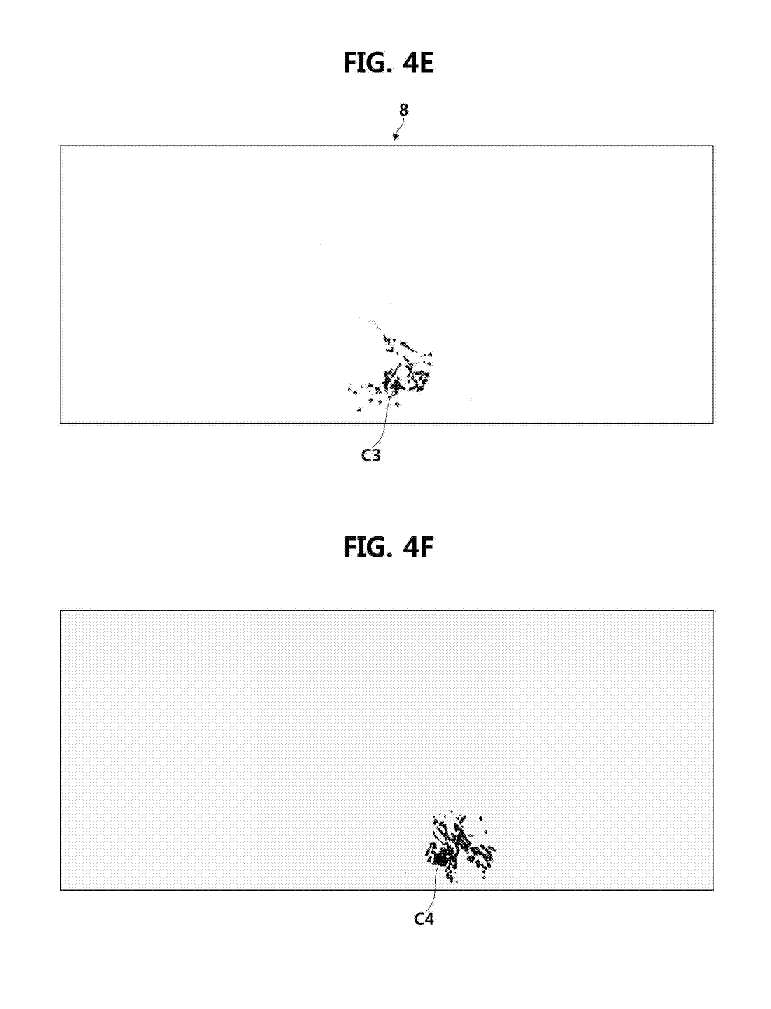

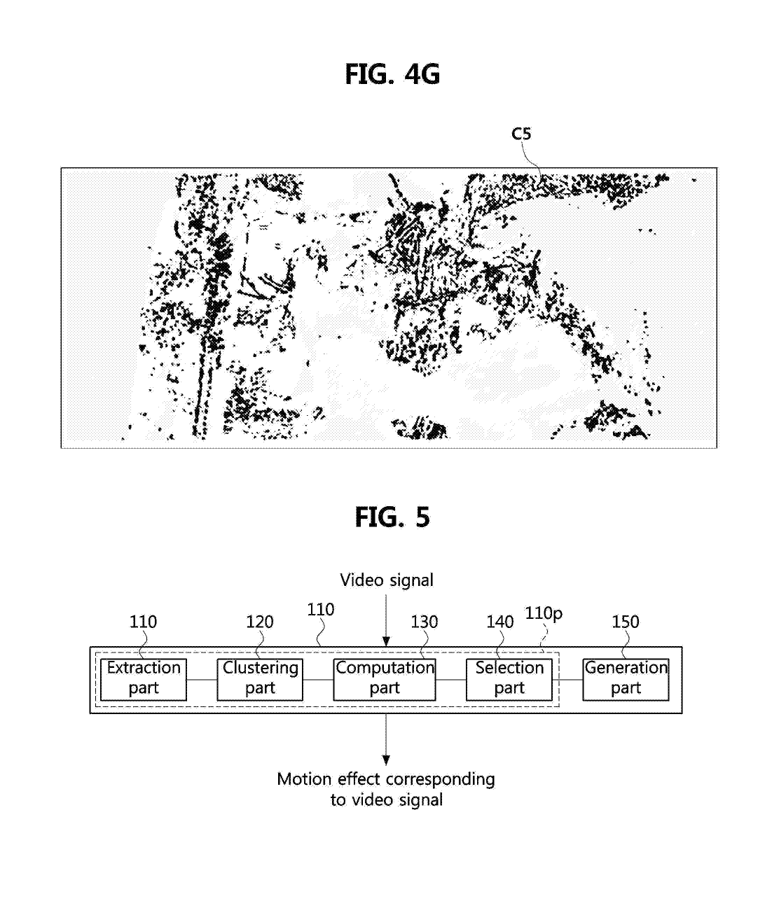

FIG. 4A through FIG. 4G are exemplary views explaining a video to which the motion effect generation method of FIG. 1 is applied.

FIG. 4A illustrates an original image 7 before applying the method according to the present disclosure, and FIG. 4B illustrates a result image 8 after applying the method according to the present disclosure. Hereinafter, the result image 8 may also be referred to as ‘motion image’.

The two images represent a combat scene of a movie. FIG. 4B may represent the result of a motion image clustering. In the motion image 8, lines 11 may represent optical flow information. Each of the clusters C1, C2, C3, C4 and C5 to the motion image 8 is separately illustrated in FIGS. 4C, 4D, 4E, 4F and 4G for convenience of illustration.

Also, in the motion image 8, it can be identified that regions corresponding to a sword 12 may be grouped into the same clusters (refer to FIGS. 4D to 4F). The circles 13 and bold lines 14 may represent representative motions of respective clusters shown in FIGS. 4C, 4D and 4E. In case that the cluster whose representative motion has the largest absolute value is selected, the cluster C2 corresponding to the end of the sword is selected. Thus, a natural motion effect can be generated along the direction of motion of the sword.

As described above, the motion effect generation method according to an exemplary embodiment of the present disclosure may be efficiently used for generating motion effects of 4D movie content. For example, it can be used for producing motion effects of 4DX movies in 4DX theaters operated by CJ CGV in Korea.

As a representative example, the method according to the present disclosure may be efficiently used for combat scenes where various and frequent motions exist. That is, according to the various motions (e.g., flourishing a sword, protecting with a shield, etc.) occurring when a heroine fights against a monster, motion effects suitable to the various motions can be efficiently generated. For example, for a scene where a sword is smashed, a chair on which the user sits can be rapidly tilted from the back side to the front side so that a feeling of realism can be provided to the used. Like this, although a professional producer should design motion effects one by one by watching a subject movie repeatedly in the conventional producing environment, the method according to the present disclosure can automatically generate motion information of such the motion effects, and efficiently output the motion effects by using the motion information.

More specifically, in the scene where the heroine smashes the sword against the monster, the motion of the sword may be represented remarkably. Thus, according to the above-described clustering methods, pixels corresponding to the sword can be grouped into the same cluster, the cluster corresponding to the sword may have the biggest motion in the video, and the cluster can be selected. Also, the direction toward which the sword is smashed can be the representative motion of the selected cluster, and the motion effect for tilting the chair can be automatically generated based on the representative motion.

The above-described methods are more efficient as compared to the conventional methods using usual object tracking methods because it is difficult for the usual object tracking method to detect a trackable object due to rapid and instantaneous motions of the action movie. For example, the scene where the sword is smashed is sustained less than 1 second, and immediately a scene of a counterattack for the sword attack can follow the previous scene. In addition, the conventional object tracking method needs manual operations of indicating trackable objects, and thus the amount of the manual operations may increase significantly. However, according to the methods according to the present disclosure, representative motions of respective clusters and the cluster suitable for generating the proper motion effect are automatically determined, and 4D effects for the video can be automatically generated even without additional inputs or manual operations of professional producers.

FIG. 5 is a block diagram of a motion effect generation apparatus based on the motion effect generation method of FIG. 1.

Referring to FIG. 5, the apparatus 100 according to an exemplary embodiment may comprise an extraction part 110, a clustering part 120, a computation part 130, a selection part 140, and a generation part 150. At least one of the extraction part 110, the clustering part 120, the computation part 130, the selection part 140, and the generation part 150 may be executed by using a microprocessor, a mobile processor, or an application processor. Also, the apparatus 100 may comprise a memory system connected to the processor.

More specifically, the extraction part 110 of the apparatus 100 may extract motions between sequential frames (e.g., two frames). The clustering part 120 may generate clusters of similar motions by grouping the motions. The computation part 130 may calculate representative motions of respective clusters. The selection part 140 may select a cluster (motion cluster) suitable for generating a motion effect among the clusters by comparing the representative motions of the clusters. In addition, the generation part 150 may generate the motion effect corresponding to the video signal or motion information for the motion effect based on the representative motion of the cluster selected by the selection part 140.

As described above, the extraction part 110 may use an optical flow method or a feature point matching method to extract the motions between sequential frames. The clustering part 120 may use a K-means clustering method or a spectral clustering method in order to generate the clusters by grouping similar motions.

In addition, the computation part 130 may calculate representative motions of respective clusters by calculating arithmetic means of all flows of respective clusters or median values of all flows of respective clusters. The selection part 140 may select a cluster whose representative motion has the largest absolute value or a cluster having the largest visual saliency among the generated clusters as the cluster (motion cluster) suitable for generating a motion effect. The generation part 150 may generate and output the motion effect or motion information for the motion effect based on the representative motion of the selected cluster.

According to another exemplary embodiment, the extraction part 110, the clustering part 120, the computation part 130, and the selection part 140 may correspond to a motion information generation apparatus or a motion information generation module 100p which provides motion information for a motion effect before generation of the motion effect based on the representative motion of the selected cluster. In this case, the generation part 150 may correspond to a motion effect generation module 150p which generates the motion effect for the motion apparatus based on the motion information provided by the motion information generation module.

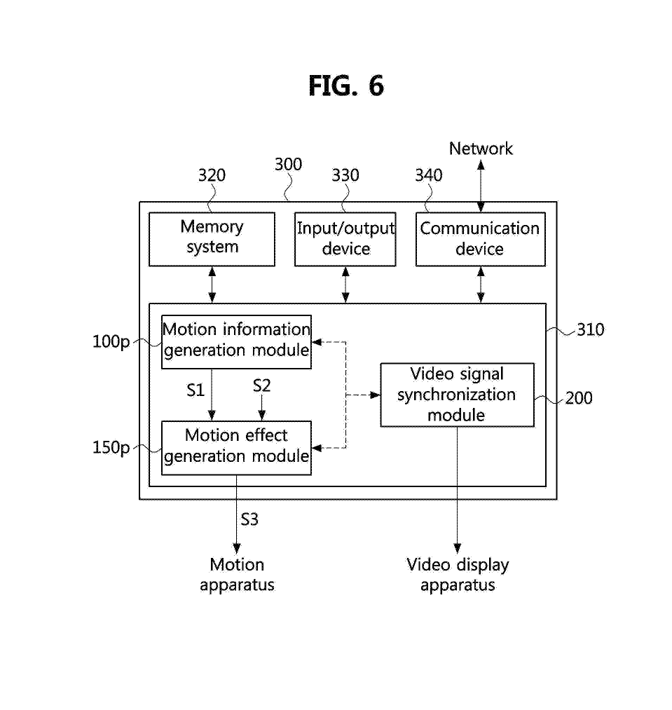

FIG. 6 is a block diagram illustrating a variation of the motion effect generation apparatus in FIG. 5.

Referring to FIG. 6, an apparatus 300 for generating motion effects according to an exemplary embodiment may comprise a processor 310, a memory system 320, an input/output device 330, and a communication device 340. Also, the processor 310 may comprise a motion information generation module 100p, a motion effect generation module 150p, and a video signal synchronization module 200.

The apparatus 300 may be connected to a motion apparatus or a driving apparatus of the motion apparatus, and transmit motion information for a motion effect or data/signal corresponding to the motion effect or the motion information to the motion apparatus or the driving apparatus to make the motion apparatus output the motion effect. According to another exemplary embodiment, the apparatus 300 may be embedded in the motion apparatus. However, various exemplary embodiments are not restricted thereto.

Also, the apparatus 300 may be implemented as a computer system comprising the processor 310, the memory system 320, the input/output device 330, and the communication device 340. Here, the computer system may be a desktop computer, a tablet computer, a personal digital assistance (PDA), or a smart phone which includes a microprocessor, an application processor, or any other type of processor capable of performing similar functions.

More specifically, the processor 310 may execute a program code in which the motion information generation module 100p generates motion information, the generated motion information or data or signal (S1) including the generated motion information is transferred to the motion effect generation module 150p, the motion effect generation module 150p converts the motion information into a motion effect, and the motion effect or data or signal (S3) corresponding to the motion effect is transferred to the motion apparatus in predefined format according to synchronization signals of the video signal synchronization module 200.

For this, the processor 310 may be configured to execute the program (here, the program includes a program code implementing the methods for generating motion information corresponding to the motion effect) stored in the memory system 320, apply user inputs (e.g., S1) obtained from the input/output device 330 to the motion effect, or apply external inputs (e.g., S2) obtained from the communication device 340 to the motion effect.

The processor 310 may comprise an arithmetic logic unit (ALU) performing computations, registers for storing data and instructions, and a controller controlling or managing interfaces between middleware. Also, the processor 310 may load the motion information generation module, the motion effect generating module, and a video signal synchronization module from the memory, and convert the motion information inform motion effects through operations of respective modules or interoperation between the modules. That is, the processor 10p may provide data or signal S3 corresponding to the motion effect synchronized with the video signal to the motion apparatus.

The processor 310 may have one of various architectures such as Alpha of Digital corporation, MIPS of MIPS technology corporation, NEC corporation, IDT corporation, or Siemens corporation, x86 of Intel, Cyrix, AMD, and Nexgen, and PowerPC of IBM and Motorola.

In the exemplary embodiment, the motion information generating module 100p and the motion effect generation module 150p may respectively correspond to the motion information generation module 100p and the generation part 150 of the apparatus for generation motion effects which were explained referring to FIGS. 1 to 5.

The video signal synchronization module 200 may transfer a first video signal inputted or read out from a medium to the motion information generation module 100p, and output a second video signal to a video display apparatus according to internal synchronization signals. That is, the video signal synchronization module 200 is a module for synchronizing the second video signal outputted from the video display apparatus with the motion apparatus for outputting the motion effect corresponding to the second video signal. For example, the video signal synchronization module 200 may output, as the second video signal, a video signal delayed for a predetermined time from the first video signal provided to the motion information generation module.

Also, the video signal synchronization module 200 may be omitted according to a processing speed, etc. of the processor used in the motion effect generation apparatus according to an exemplary embodiment.

The memory system 320 may include a main memory such as a Random Access Memory (RAM) and a Read-Only Memory (ROM), and a secondary memory which is a long-term storage medium such as a Floppy disc, hard disc, tape, CD-ROM, and Flash memory. The memory system 320 may be connected to the processor 310, store data corresponding to input signals from the processor, or read out the stored data when the motion effect generation apparatus of FIG. 5 performs the motion effect generation method of FIG. 1.

Also, the memory system 320 may include a recording medium on which program codes for executing methods for generating motion effects according to exemplary embodiments of the present disclosure are recorded.

The input/output device 330 may comprise at least one of various devices such as an input port, an output port, a keyboard, a mouse, a display apparatus, and a touch panel. The input port may be connected to a drive apparatus of a recording medium, and be configured to receive motion information or program codes stored in the recording medium. Here, the keyboard or mouse may include a physical transducer such as a touch screen or a microphone. Also, the input/output part 14 may include a video graphic board for proving graphical images used for inputting or responding to queries or for managing the apparatus.

The communication device 340 may be connected with another communication apparatus via a network. Also, the communication device 340 may receive program codes implementing methods for generating motion effects, user inputs, or data necessary for generating motion effects through the network. The communication device 340, as a network interface performing communications with the middleware or the user interface, may include a wire communication interface or a wireless communication interface. In some exemplary embodiments, the communication device 340 may act as means or a component receiving program codes or motion information from a server or a storage system on the network.

In an exemplary embodiment, the motion effect generation apparatus 300 may have a structure in which at least one of the video signal synchronization module, the motion information generation module, and the motion effect generation module is included in the processor. In addition, at least one of the memory system, the input/output device, and the communication device may be used for inputting the video signal.

While the exemplary embodiments of the present invention and their advantages have been described in detail, it should be understood that various changes, substitutions and alterations may be made herein without departing from the scope of the invention.

What is claimed is:

1. A motion effect generation apparatus, the apparatus comprising:
an extraction part extracting motions between sequential frames by calculating relations of respective pixels of the sequential frames in a first video signal;
a clustering part generating clusters of similar motions by grouping the motions;
a computation part calculating representative motions of respective clusters; and
a selection part selecting a cluster suitable for generating a motion effect among the clusters by comparing the representative motions of the respective clusters,
wherein the apparatus outputs motion information of the motion effect based on the representative motion of the cluster selected by the selection part.

2. The apparatus according to claim 1, further comprising a generation part generating the motion effect based on the representative motion of the cluster selected by the selection part.

3. The apparatus according to claim 2, wherein the generation part uses a washout filter or a trajectory planning method.

4. The apparatus according to claim 2, further comprising a synchronization part outputs a second video signal delayed for a predetermined time as compared to the first video signal inputted to the extraction part, wherein the second video signal is synchronized with the motion effect outputted by the generation part.

5. The apparatus according to claim 1, wherein the extraction part uses an optical flow method or a feature point matching method.

6. The apparatus according to claim 1, wherein the clustering part uses a K-means clustering method, a single linkage clustering method, or a spectral clustering method.

7. The apparatus according to claim 1, wherein the computation part selects arithmetic means or median values of all motions of the respective clusters as the representative motions for respective clusters.

8. The apparatus according to claim 1, wherein the selection part select a cluster whose representative motion has the largest absolute value or a cluster having the largest visual saliency as the cluster suitable for generating the motion effect.

9. A motion effect generation method, the method comprising:
extracting motions between sequential frames by calculating relations of respective pixels of the sequential frames in a first video signal;
generating clusters of similar motions by grouping the motions;
calculating representative motions of respective clusters; and
selecting a cluster suitable for generating a motion effect among the clusters by comparing the representative motions of the clusters.

10. The method according to claim 9, further comprising generating the motion effect based on the representative motion of the selected cluster.

11. The method according to claim 9, wherein the generating clusters uses a washout filter or a trajectory planning method.

12. The method according to claim 9, further comprising outputting a second video signal delayed for a predetermined time as compared to the first video signal wherein the second video signal is synchronized with the motion effect.

13. The method according to claim 9, wherein the extracting uses an optical flow method or a feature point matching method.

14. The method according to claim 9, wherein the generating clusters uses a K-means clustering method, a single linkage clustering method, or a spectral clustering method.

15. The method according to claim 9, wherein, in the calculating the representative motions, arithmetic means or median values of all motions of the respective clusters as the representative motions for the respective clusters.

16. The method according to claim 9, wherein, in the selecting the cluster, a cluster whose representative motion has the largest absolute value or a cluster having the largest visual saliency as the cluster suitable for generating the motion effect is selected.

17. A motion effect generation apparatus, the apparatus comprising:
a video signal synchronization module outputting a first video signal based on an input video signal and outputting a second video signal delayed from the first video signal;
a motion information generation module outputting motion information based on a representative motion of a cluster selected from the first video signal; and
a motion effect generation module generating a motion effect based on the motion information and outputting the motion effect synchronized with the second video signal,
wherein the motion information generation module extracts motions between two frames by calculating relations of respective pixels of the two frames in the first video signal, generates clusters of similar motions by aggregating the motions, calculates representative motions of respective clusters, selects a cluster suitable for generating a motion effect from the clusters by comparing the representative motions of the clusters, and outputs the representative motion of the selected cluster as the motion effect.

18. The apparatus according to claim 17, wherein at least one of the video signal synchronization module, the motion information generation module, and the motion effect generation module is executed by a processor.

19. The apparatus according to claim 17, further comprising at least one of a memory system, an input/output device, and a communication device for providing the input video signal.
